(19) United States
(12) Patent Application Publication
(10) Pub. No.: US 2002/0097689 A1
(43) Pub. Date: Jul. 25, 2002

(54) Cellular time division telecommunications systems

(76) Inventors: Stephane Eloy, Courbevoie (FR); Hamid Reza Falaki, Swindon (GB); Hamid Reza Karimi, Swindon (GB); Yvon Le Goff, Perros-Guirec (FR)

Correspondence Address: Docket Administrator (Room 3J-219), Lucent Technologies Inc., 101 Crawfords Corner Road, Holmdel, NJ, 07733-3030, US

(21) Appl. No.: 10/042,595

(22) Filed: Jan. 9, 2002

(30) Foreign Application Priority Data
Jan. 24, 2001 (EP) 01300598.8

(51) Int. Cl. H04J 3/00

(52) U.S. Cl. 370/280; 370/329; 370/341

(57) ABSTRACT

To reduce interference between physically close base and mobile stations belonging to uncoordinated systems of different operators, in a cellular time division telecommunications system, e.g. the TDD mode of UMTS, a method of operation comprises providing a sequence of time frames, each time frame including a plurality of time slots, each time slot having an allocated uplink or downlink channel, wherein the positions of said time slots of said channels are changed in consecutive time frames of said sequence according to a deterministic sequence, e.g. a cyclic rotation. In an initial set up operation, the base station may instruct a mobile station to transmit or receive in certain time slots, and that these time slots should be changed in succeeding frames according to a predefined algorithm transmitted to the mobile station.

### BACKGROUND OF THE INVENTION

I. Field Of The Invention

The present invention relates to cellular time division telecommunications systems, particularly though not exclusively UMTS (“Universal Mobile Terrestrial System”).

II. Description of the Related Art

In the present specification, the term base station refers to a radio station controlling a cell, and includes a Node B of a UMTS system. The term mobile station refers to a user device, which may move from cell to cell, and includes User Equipment of a UMTS system.

A problem of interference arises, particularly when two base stations belonging to different operators, or belonging to the same operator but operating in uncoordinated modes, are positioned close to one another. This problem is particularly acute with UTRA-TDD (Time Division Duplex) where both uplink (UL) and downlink (DL) transmissions take place on a single wideband (5 MHz) frequency channel. There is a significant risk that uncoordinated base stations will be operating at the same or adjacent frequency channels. The situation is not as serious for GSM, where UL and DL transmissions are separated in frequency, and there is a wide range of frequency channels available, both for UL and DL.

The hereinabove situation is illustrated in FIG. 1. Two uncoordinated base stations BTS1, BTS2 belonging to different UTRA-TDD operators 1 and 2, occupy adjacent-channels (frequencies f₁ and f₂=f₁±5 MHz) serving the same geographical area. FIG. 1 depicts the interference possibilities between the base stations BTS 1, 2 and mobile stations MS1, MS2 belonging to the two operators. It is assumed there is no coordination or synchronization between the two operators. This is a realistic assumption and precludes any form of cooperative dynamic channel allocation. It is also assumed that Uplink/Downlink switching points may or may not be the same in the two systems, although in this example they are shown the same for simplicity. Two types of adjacent-channel interference exist in such environments:

1. BTS-to-MS & MS-to-BTS—This is characteristic of all cellular systems, FDD or TDD. Any mobile station receives interference from adjacent-channel downlink transmissions by other base stations. Similarly a base station receives interference from adjacent-channel uplink transmissions by other mobile stations; and

2. BTS-to-BTS & MS-to-MS—This is characteristic of TDD systems only, where radios transmit and receive at the same frequency. In a FDD system, the duplex frequency separation between the uplink and downlink (130 MHz for UTRA-FDD) allows the adjacent-channel interference between two mobile stations or two base stations to be suppressed via appropriate filtering at the receiver.

In UTRA-TDD, the duplex separation between uplink and downlink is zero and the interference can be significant, especially between closely-spaced radios. The difference between FDD and TDD in this respect is shown in FIG. 2 for the case of MS-to-MS interference, where MS-2 is transmitting on an uplink and MS1 is receiving on a downlink. It may be seen that in UTRA-FDD a mobile station's receiver is immune to transmissions from other mobile stations due to the duplex separation. In UTRA-TDD, closely positioned mobile stations can result in significant interference.

FIG. 3 depicts the situation in UTRA-TDD when MS1 in system-1 is allocated channels in slots 7, 8, 9 and MS2 in system-2 is allocated channels in slots 5, 6, 7. Due to the lack of coordination between the two systems, significant interference between the two mobile stations occurs.

The problem of such TDD interference is discussed in “WCDMA for UMTS” Holma et al., Wiley, 2000, pages 296-301. After a discussion of the issues involved, it is concluded that frame-level synchronisation of each operators' UTRA-TDD base stations is required.

However, the option of synchronisation between different operators clearly involves the goodwill and agreement of the different operators, which may not in all circumstances be forthcoming.

### Summary Of The Invention

It is an object of the invention to overcome or at least reduce the above mentioned problem of interference.

The present invention provides in a first aspect, in a cellular time division telecommunications system, a method of operation comprising providing in a radio link a sequence of time frames, each time frame including a plurality of time slots, each time slot having an allocated channel, characterised in that the positions of said time slots and/or said allocated channels are changed in subsequent time frames of said sequence in a predetermined manner.

In a further aspect, the invention provides in a cellular telecommunications system, apparatus for providing time division operation in a radio link between a base station and mobile stations within the cell of the base station, comprising: means for providing a series of time frames, each time frame including a plurality of time slots, means for allocating a predetermined uplink or downlink channel to each said time slot, characterised by means for changing the positions of said time slots and/or the allocated channels in subsequent frames of the series in a predetermined manner.

Where the system of the invention is UMTS or GSM, said channels are termed physical channels. In UMTS, time frames and time slots are defined as a continuous sequence of time intervals—see 3GPP TS 25.221. In a series of time frames, a physical channel is allocated one or more time slots within each frame. In accordance with the invention, in the situation where a mobile station has perhaps a section of adjacent time slots allocated to it within each time frame, the position of these time slots is changed from frame to frame. Thus, if another uncoordinated operator with an adjacent cell has a mobile station with a similar section of adjacent time slots, the risk of interference of the time slots over a sequence of frames is drastically reduced, since although the time slots may overlap in one frame period, in the succeeding frame period, the time slots will probably not overlap, at least not to the same extent. In such a system, the present invention is implemented by changing the physical channel allocation for the mobile station from frame to frame. However the present invention does not exclude systems wherein it is appropriate to change the time slot positioning subsequent to channel allocation.

The present invention is not dependent on each uncoordinated operator implementing the invention. Only one operator need implement the invention in order to “break-up” any significant interference between neighbouring mobile stations.

The invention is applicable both to reducing interference between mobile stations, and to reducing interference between base stations.

In a practical situation, the channels allocated to particular time slots will change over a period of time, as one call function is completed and another channel is allocated for another function. The changing, in accordance with the invention, of the order of the channels in consecutive time frames is independent of any such long term changing of channels allocated. However it is possible in accordance with the invention to dynamically initiate or terminate the method of the invention in accordance with the nature of the channel allocation. For example if one mobile station has allocated a consecutive block of time slots for downlink transmission, it would be desirable to initiate the method of the invention. It is further possible that only some of the entire set of the slots within a time frame (15 for UMTS) are subject to the method of the present invention.

The predetermined manner of changing the positions of the channels, or time slots, is preferably a deterministic sequence. The channels or time slots of adjacent frames may be merely rotated by one or a predetermined number so that time slot 1 in one frame becomes time slot 2 or (2+n) in the next frame, and time slot 3 or (3+2n) in the second succeeding frame. However, other sequences may be envisaged, as for example a known predetermined pseudo-random sequence, or a sequence obtained by consulting a table of values

In a preferred method of implementation, when a mobile station is synchronised with a base station, the mobile station is instructed to receive or transmit with appropriate channels on predetermined time slots within each frame. The mobile station is instructed that the time slots should be computed for each successive frame in accordance with a predefined algorithm, as will become clear hereinafter.

### BRIEF DESCRIPTION OF THE DRAWINGS

The present invention will be better understood from reading the following description of non-limiting embodiments, with reference to the attached drawings, wherein below:

FIG. 1 is a schematic view showing potential sources of interference in UTRA-TDD systems of uncoordinated operators;

FIG. 2 is a schematic graphical representation of neighbouring frequency bands in respective FDD and TDD systems of uncoordinated operators;

FIG. 3 is a schematic view of time slots within time frames of two uncoordinated operators showing the risk of interference;

FIG. 4 is a sequence of diagrams showing time frames of uncoordinated operators and implementing the method in accordance with the invention; and

FIG. 5 is a schematic block diagram of a base station and mobile station incorporating a preferred embodiment of the invention.

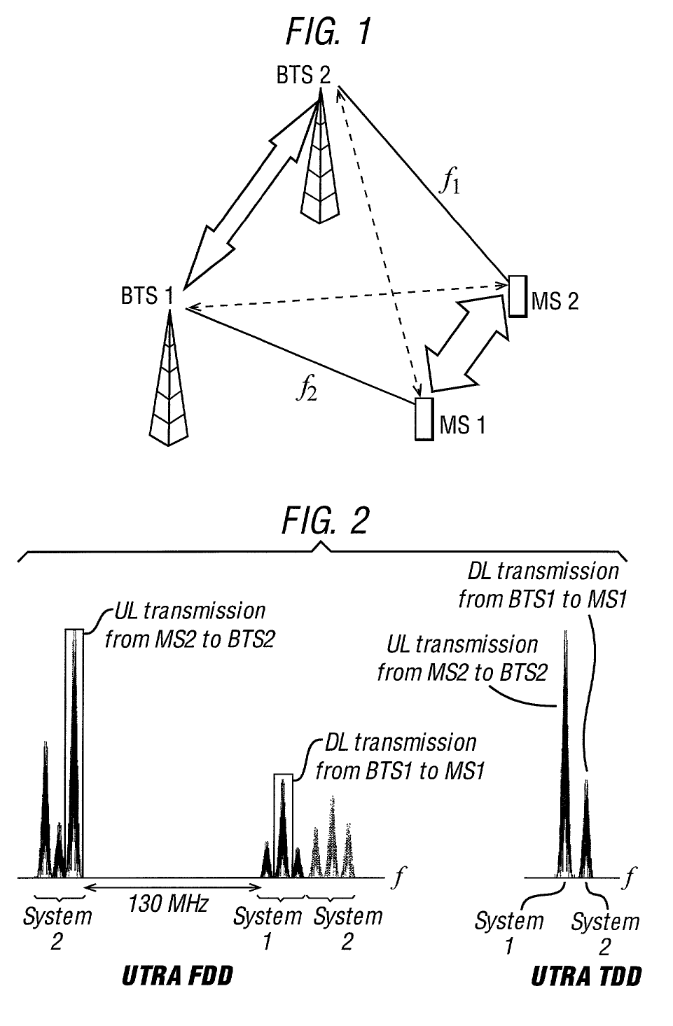

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

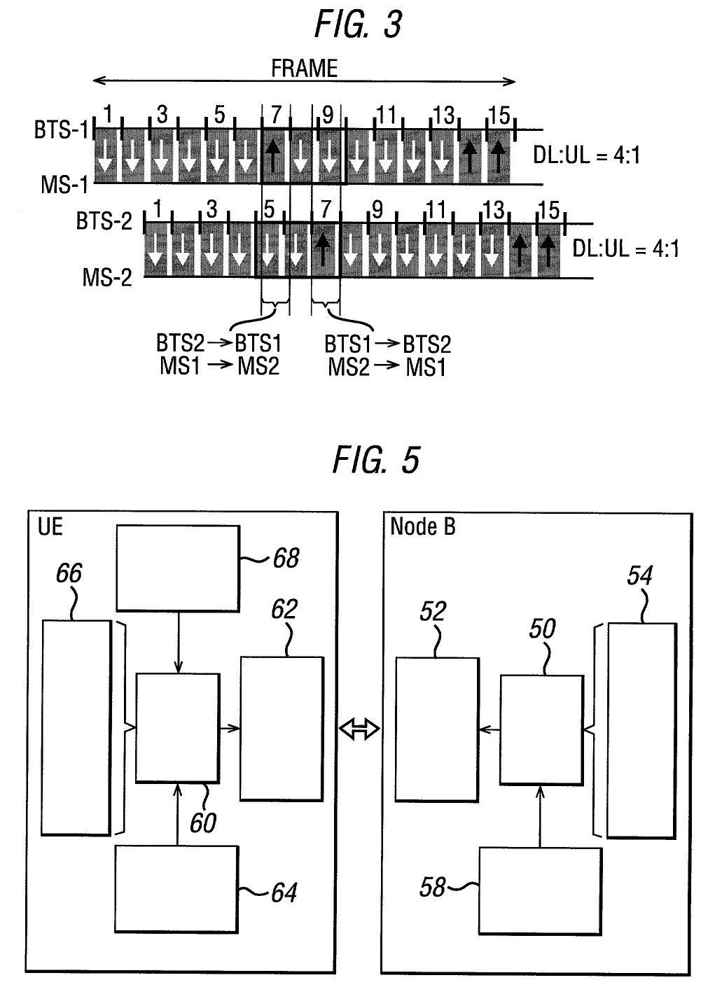

In UTRA-TDD signal bursts are transmitted in sequential frames (radio frames), each ten milliseconds long. There are fifteen time slots within each frame and each time slot occupies 0.577 milliseconds. In the case of asymmetric allocation of time slots, for example Internet data traffic, there is a significant risk that two closely spaced mobile stations belonging to different operators may have a group of consecutive time slots which overlap one another in time. If one mobile station is transmitting while the other is receiving in such time slots, there is a risk of significant interference between the mobile stations. This is shown in FIG. 3 where in slot 7 of system 1, mobile station MS-1 is transmitting in an uplink slot, and this overlaps slot 5 in system 2 where mobile station 2 is receiving in a downlink slot. Significant interference will therefore occur. Interference will not occur to such an extent in slot 8 of system 1 and slot 6 of system 2 since both are downlink slots, but significant interference will arise again during slot 9 of system 1 which is a downlink slot, and slot 7 of system 2 which is an uplink slot where mobile station 2 is transmitting.

With fixed slot allocation, the closely-spaced mobile stations will strongly interfere with one another for the total duration of the calls. The interference is distributed in accordance with the invention across all mobile stations in the two cells by “time slot hopping.” Each operator is assigned a unique deterministic “hopping sequence” to ensure appropriate interference averaging amongst the mobile stations.

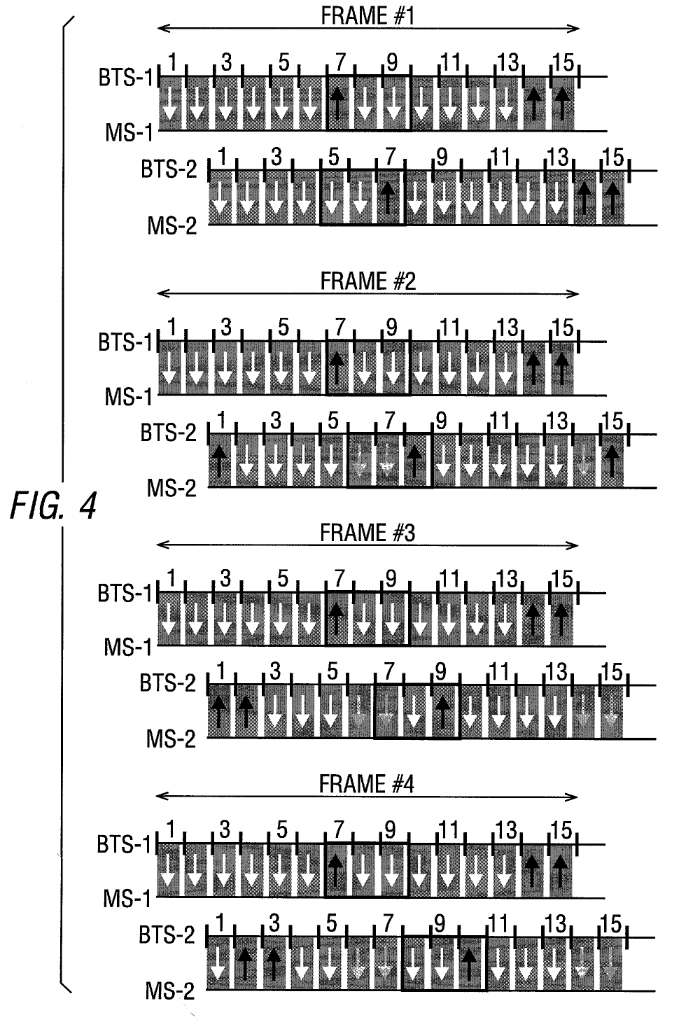

In one realization, the hopping sequence can simply consist of a cyclic shift of the slot-allocations in succeeding frames. For example, while the time slot allocations are fixed for one operator, the time slot allocations can be advanced/retarded by n slots per frame for the adjacent channel operators. This is illustrated in FIG. 4 for the case of n=1 and four frames.

Time slot hopping mitigates both the MS-to-MS interference and the BTS-to-BTS interference. The BTS-to-BTS interference can be further controlled by the use of directional antennas and sectorization.

Referring to FIG. 5, each base station (Node B) has a means 50 for defining 15 time slots within each 10 ms radio frame for a transceiver 52, and a processor 54 for allocating or scheduling the time slots within each frame with uplink or downlink physical channels . This scheduling is done by the upper layers of the network in the manner prescribed by the relevant 3GPP standards. In particular the transport and logical channels of the MAC and RLC layers are employed in accordance with the requirements for the network. A means 58, comprising a processor and stored algorithm, is provided for cyclically rotating the time slot sequence (i.e. the channel allocation) for successive frames by a predetermined number of time slots.

Similarly, each mobile station UE has means 60 defining a time slot structure similar to that of the node B for a transceiver 62. In addition, means 64 are provided in each UE for synchronising the time slots of the UE with those of the node B. A processor 66 allocates or schedules the time slots within each frame with uplink or downlink physical channels in cooperation with means 54 in Node B. The UE has a means 68, comprising a processor and stored algorithm, for cyclically rotating the time slot sequence (channel allocation) for successive frames by a predetermined number of time slots.

In use, When UE registers with Node B on entry to the cell, UE synchronizes its time-base with means 64 to that of the Node B. At call set-up, the Node B instructs the UE to receive on slots (say) nr1 and nr2 and to transmit on slot (say) nt1 and at each frame to update the slot indexes by the following rule:

nr1=nr1+shift_value; if nr1>15 then nr1=nr1−15;

nr2=nr2+shift_value; if nr2>15 then nr2=nr2−15;

nt1=nt1+shift_value; if nt1>15 then nt1=nt1−15;

which is basically a cyclic shift. The above algorithm is known at both the Node B and UE in means 58, 68. Parameters such as shift-value may be defined at call set-up by transmission to the UE. The above is just an example: more complex algorithms my be employed.

Thus, as shown in FIG. 4, in the case where there are two uncoordinated operators transmitting and a first operator (BTS-1, MS-1) is transmitting a constant time slot sequence from frame to frame, and operator 2 (BTS-2, MS-2) having a time slot sequence which changes in accordance with the arrangement shown in FIG. 5 by cyclic rotation of one time slot per frame, the following situation may occur. As shown in FIG. 4 for system 1 slots 7, 8 and 9 are designated for mobile station 1, slot 7 being an uplink slot and slots 8 and 9 being downlink slots. For system 2 slots 5, 6 and 7 are designated for a mobile station 2, slots 5 and 6 being downlink slots and slot 7 being an uplink slot. Since mobile stations 1 and 2 are in close physical proximity, there is significant risk of interference during slot 5 of system 2 and slot 7 of system 2 wherein one mobile station is transmitting while the other is receiving. In the next frame, frame 2, for system 2, the slots allocated to mobile station 2 are now slots 6, 7 and 8, so that only slots 6 and 7 overlap with slots and 8 and 9 of system 1. Slot 8 of system 2 now occurs in slot 10 of system 1, which is designated for another mobile station. In slots 6 and 7 of system 2, these are both downlink slots, as are slots 8 and 9 of system 1. Thus, there is a reduced risk of interference between the two mobile stations in this frame.

In frame 3, as shown in FIG. 4, the slots reserved for mobile station 2 now occur in slots 7, 8 and 9, so that there is only overlap between the two mobile stations in slot 7 of system 2 which overlaps with slot 9 of system 1. Since these are both downlink slots, there will be a reduced risk of interference in this time frame.

n frame 4, the slots reserved for mobile station 2 in system 2 now occur in slots 8, 9 and 10, wherein there is no substantial overlap with slots 7, 8 and 9 of system 1. Thus, in frame 4 there will be no interference between the two mobile stations.

The cyclic rotation of the slots in system 2 continues and the risk of interference between the two mobile stations does not reappear until the slots reserved for mobile station 2 reappear in slot 5 of system 2. There then occurs interference periods while the time slots for mobile system 2 overlap in time with those of mobile station 1.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A method of operating a telecommunications system comprising the steps of providing in a radio link, a sequence of time frames, each time frame including a plurality of time slots, each time slot having an allocated channel, characterised in that the positions of said time slots and/or said allocated channels are changed in subsequent time frames of said sequence in a predetermined manner.

2. The method according to claim 1, wherein the positions of said time slots and/or said allocated channels are changed in consecutive time frames of said sequence.

3. The method according to claim 1, wherein said predetermined manner is provided by a deterministic sequence.

4. The method according to claim 3, wherein the sequence is a cyclic rotation of the channel positions.

5. The method according to claim 4, wherein the cyclic sequence rotates the time slots by one time slot within each succeeding time frame.

6. The method according to claim 3, wherein a mobile station computes the sequence as a real time computation for each time frame.

7. The method according to claim 1, wherein in an initial set up operation, a base station instructs a mobile station to transmit and/or receive in certain time slots, and that these time slots should be changed in subsequent frames in accordance with an algorithm.

8. The method according to claim 7, wherein the base station transmits at least part of the algorithm to the mobile station.

9. The method according to claim 1, wherein said plurality of time slots constitute all the time slots of the time frame.

10. The method according to claim 1, wherein the system is UMTS operating in TDD mode, each base station is a node B and each mobile station is a UE, and said channels are physical channels.

11. An apparatus for providing time division operation of a telecommunications system in a radio link between a base station and mobile stations, the apparatus comprising:
means for providing a series of time frames, each time frame including a plurality of time slots, means for allocating a predetermined channel to each said time slot, characterised by means for changing the positions of said time slots and/or the allocated channels in subsequent frames of the series in a predetermined manner.

12. The apparatus according to claim 11, wherein said means for changing changes the positions of said time slots and/or said allocated channels in consecutive time frames of said sequence.

13. The apparatus according to claim 11, wherein said predetermined manner is provided by a deterministic sequence.

14. The apparatus according to claim 13, wherein the sequence is a cyclic rotation of the channel positions.

15. The apparatus according to claim 14, wherein the cyclic sequence rotates the time slots by one time slot within each succeeding time frame.

16. The apparatus according to any of claim 13, further comprising a mobile station having means to compute the sequence as a real time computation for each time frame

17. The apparatus according to claim 11, further comprising a base station for instructing a mobile station to transmit and/or receive in certain time slots, and to instruct the mobile station that these time slots should be changed in subsequent frames in accordance with an algorithm.

18. The apparatus according to claim 17, wherein the base station is arranged to transmit at least part of the predefined algorithm to the base station.

19. The apparatus according to claim 11, wherein said plurality of time slots constitute all the time slots of the time frame.

20. The apparatus according to any of claim 11, wherein the system is UMTS operating in TDD mode, each base station is a node B and each mobile station is a UE, and said channels are physical channels.
